(19) United States
(12) Patent Application Publication
(10) Pub. No.: US 2026/0188287 A1
(43) Pub. Date: Jul. 2, 2026

(54) INPUT DETECTION SYSTEM

(71) Applicant: Japan Display Inc., Tokyo (JP)

(72) Inventors: Takuya NISHIMOTO, Tokyo (JP); Koji YOSHIDA, Tokyo (JP); Hiroshi YAMAGUCHI, Tokyo (JP)

(73) Assignee: Japan Display Inc., Tokyo (JP)

(21) Appl. No.: 19/424,450

(22) Filed: Dec. 18, 2025

(30) Foreign Application Priority Data
Dec. 26, 2024 (JP) 2024-230623

(51) Int. Cl. G10H 1/34; G10H 1/00

(52) U.S. Cl. CPC G10H 1/344; G10H 1/0008; G10H 2220/221; G10H 2220/295

(57) ABSTRACT

According to an aspect, an input detection system includes: a capacitive sensor disposed on a first surface of an insulating plate and provided with a plurality of detection electrodes on a detection surface; an input device that is disposed on a second surface of the insulating plate and includes at least one input key including a detection conductor and capable of changing a distance between the detection conductor and the insulating plate depending on depression; a detection circuit coupled to the capacitive sensor; and a control circuit configured to control the capacitive sensor and the detection circuit. The control circuit is configured to output an input signal corresponding to an input operation on the input device based on a detection value output from the detection circuit depending on the distance between the detection conductor and the insulating plate.

### CROSS-REFERENCE TO RELATED APPLICATION

This application claims the benefit of priority from Japanese Patent Application No. 2024-230623 filed on Dec. 26, 2024, the entire contents of which are incorporated herein by reference.

### BACKGROUND

### 1. Technical Field

What is disclosed herein relates to an input detection system.

### 2. Description of the Related Art

Japanese Patent Application Laid-open Publication No. S60-019198 (JP-A-S60-019198) describes a music keyboard. The thin keyboard described in Japanese Patent Application Laid-open Publication No. 2005-093129 (JP-A-2005-093129) incorporates a switch circuit.

The music keyboard described in JP-A-S60-019198 is integrated with a control device and other components, so there is a limit to the thinning of the keyboard. The keyboard described in JP-A-2005-093129 is an input detection system that incorporates a switch circuit and has a complex structure.

For the foregoing reasons, there is a need for an input detection system that can accurately detect input operations and is easy to use.

### SUMMARY

According to an aspect, an input detection system includes: a capacitive sensor disposed on a first surface of an insulating plate and provided with a plurality of detection electrodes on a detection surface; an input device that is disposed on a second surface of the insulating plate and includes at least one input key including a detection conductor and capable of changing a distance between the detection conductor and the insulating plate depending on depression; a detection circuit coupled to the capacitive sensor; and a control circuit configured to control the capacitive sensor and the detection circuit. The control circuit is configured to output an input signal corresponding to an input operation on the input device based on a detection value output from the detection circuit depending on the distance between the detection conductor and the insulating plate.

### BRIEF DESCRIPTION OF THE DRAWINGS

FIG. 1 is a schematic of an input device according to a first embodiment;

FIG. 2 is a diagram for explaining an input detection system according to the first embodiment;

FIG. 3 is a schematic of a capacitive sensor according to the first embodiment;

FIG. 4 is a diagram for explaining the configuration of the capacitive sensor according to the first embodiment;

FIG. 5 is a block diagram for explaining the configuration of the capacitive sensor according to the first embodiment;

FIG. 6 is a schematic of the back surface of the input device according to the first embodiment;

FIG. 7 is a schematic of a first operating state of an input key according to the first embodiment;

FIG. 8 is a schematic of a second operating state of the input key according to the first embodiment;

FIG. 9 is a flowchart of an example of the detection method of the input detection system according to the first embodiment;

FIG. 10 is a schematic of the input device according to a second embodiment; and

FIG. 11 is a schematic of the input device according to a third embodiment.

### DETAILED DESCRIPTION

Exemplary aspects (embodiments) to embody the present disclosure are described below in greater detail with reference to the accompanying drawings. The contents described in the embodiments below are not intended to limit the present disclosure. Components described below include components easily conceivable by those skilled in the art and components substantially identical therewith. Furthermore, the components described below may be appropriately combined. What is disclosed herein is given by way of example only, and appropriate modifications made without departing from the spirit of the present disclosure and easily conceivable by those skilled in the art naturally fall within the scope of the present disclosure. To make the explanation more specific, the drawings may possibly illustrate the width, the thickness, the shape, and other elements of each component more schematically than the actual aspect. These elements, however, are given by way of example only and are not intended to limit interpretation of the present disclosure. In the present disclosure and the drawings, components similar to those previously described with reference to previous drawings are denoted by the same reference numerals, and detailed explanation thereof may be omitted as appropriate.

In the present disclosure, when the term “on” is used to describe an aspect where a first structure is disposed on a second structure, it includes both of the following cases unless otherwise noted: a case where the first structure is disposed directly on and in contact with the second structure, and a case where the first structure is disposed on the second structure with still another structure interposed therebetween.

### First Embodiment

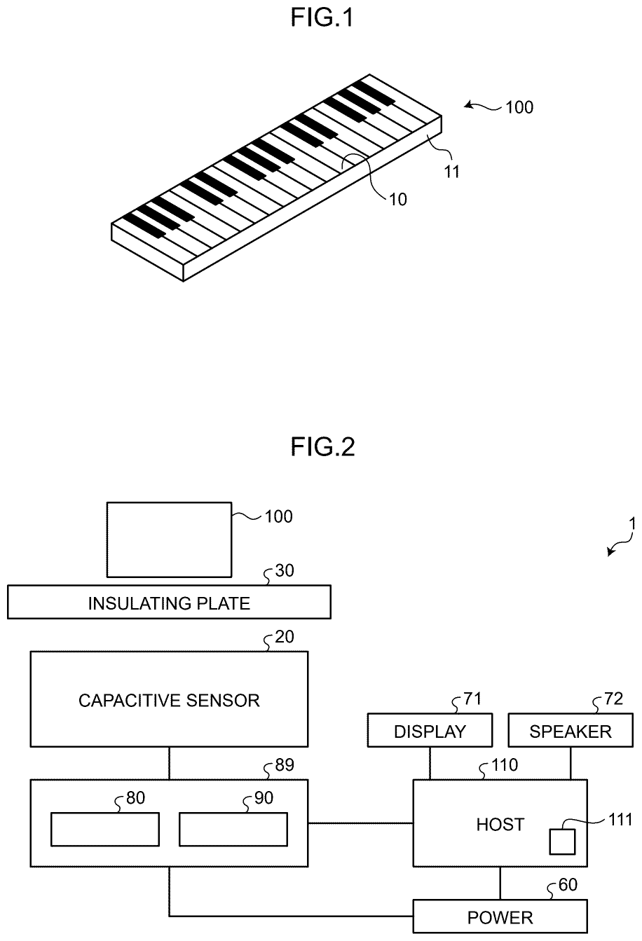

FIG. 1 is a schematic of an input device according to a first embodiment. FIG. 2 is a diagram for explaining an input detection system according to the first embodiment. As illustrated in FIG. 1, an input device 100 includes input keys 10 in a housing 11. As illustrated in FIG. 2, an input detection system 1 according to the first embodiment includes a capacitive sensor 20, an insulating plate 30, and the input device 100. In the input detection system 1, the capacitive sensor 20, the insulating plate 30, and the input device 100 are disposed in this order in a direction perpendicular to the surface of the capacitive sensor 20.

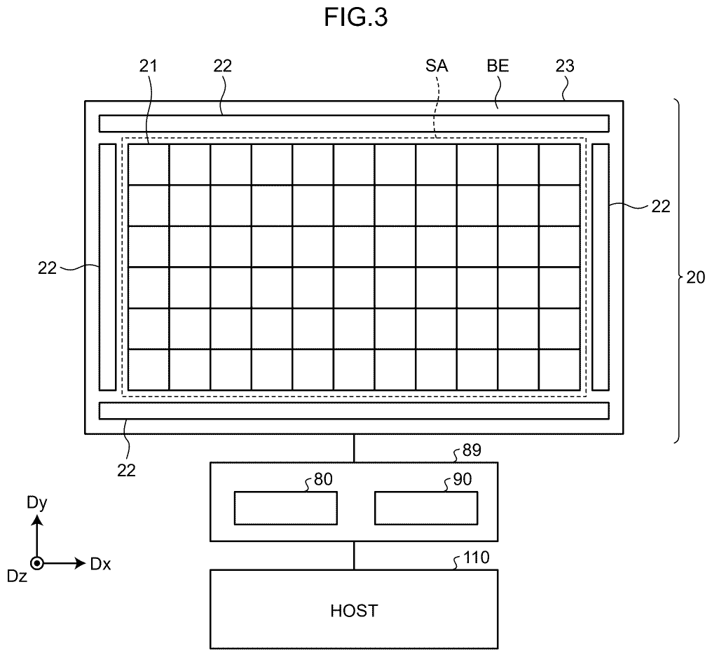

As illustrated in FIG. 2, the capacitive sensor 20 performs self-capacitance detection. More specifically, the capacitive sensor 20 detects the positions of the housing 11 and the input keys 10 serving as objects to be detected when the input keys 10 and the housing 11 are not in contact with the detection surface of the capacitive sensor 20. Alternatively, the capacitive sensor 20 detects the movement of the input keys 10 when the input device 100 including the input keys 10 is not in contact with the detection surface of the capacitive sensor 20. A configuration example of the capacitive sensor 20 will be described later with reference to FIG. 3.

The insulating plate 30 is disposed on the capacitive sensor 20 and allows the input device 100 to be placed thereon. The insulating plate 30 is a plate-like member made of insulating material, such as wood and resin material. The insulating plate 30 simply needs to be a plate-like member on which the input device 100 can be placed and may be a shelf, stand, or the like on which the input device 100 is placed.

Information is input to the input device 100 by pressing the input key 10. The input device 100 is a sound keyboard that can play music from a speaker based on the input information.

FIG. 3 is a schematic of the capacitive sensor according to the first embodiment. As illustrated in FIG. 3, an electric field is generated from a detection electrode 21 of the capacitive sensor 20 in the direction perpendicular to the capacitive sensor 20, and an electric field is also generated around the input key 10 due to capacitive coupling. With this configuration, capacitance is formed between, for example, a human body and the input key 10 due to depression of the input key 10 serving as the object to be detected. This results in a change in the magnitude of a detection value acquired from the detection electrode 21 of the capacitive sensor 20 at the position overlapping the input device 100. Thus, the input detection system 1 can detect the pressing on the input key 10.

In the input detection system 1, the input device 100 need not be coupled directly to the electrodes of the capacitive sensor 20, and the position where the input device 100 is placed on the insulating plate 30 is not constrained. Therefore, the appearance of the input detection system 1 is not impaired when the capacitive sensor 20 is disposed.

As illustrated in FIG. 2, the input detection system 1 includes a detection circuit 80, a control circuit 90, a display 71, and a speaker 72. The detection circuit 80 and the control circuit 90 are mounted on a wiring substrate 89 coupled to the capacitive sensor 20. The wiring substrate 89 is flexible printed circuits (FPC) or a rigid printed circuit board (PCB), for example.

The detection circuit 80 is coupled to a plurality of detection electrodes 21 (refer to FIG. 3) of the capacitive sensor 20. The detection circuit 80 acquires the detection values from the detection electrodes 21, performs predetermined signal processing on the detection values, and outputs them to the control circuit 90. The control circuit 90 controls the capacitive sensor 20. The control circuit 90 includes a micro control unit (MCU), for example.

The control circuit 90 is coupled to a processing device 110 (external processing device) and a power source 60. The processing device 110 is a device that functions as a host computer (HOST) of the input detection system 1. The processing device 110 includes a central processing unit (CPU) and a storage circuit 111, such as a memory. The processing device 110 executes computer programs using these hardware resources, thereby controlling the operations of the display 71 and the speaker 72. The processing device 110, for example, controls the operations of the display 71 and the speaker 72 based on the results of detection of the object to be detected by the detection circuit 80 and the control circuit 90. While the processing device 110 controls the operations of the display 71 and the speaker 72 in FIG. 2, the present embodiment is not limited thereto. Alternatively, the control circuit 90 may control the operations of the display 71 and the speaker 72.

The power source 60 supplies power supply voltage to the detection circuit 80, the control circuit 90, and the processing device 110.

FIG. 3 is a schematic of a configuration example of the capacitive sensor included in the detection system according to the first embodiment. As illustrated in FIG. 3, the capacitive sensor 20 includes a substrate 23, and a plurality of detection electrodes 21 and peripheral electrodes 22 provided on the substrate 23. When the capacitive sensor 20 alone is operated, both hover detection and touch detection can be performed. The hover detection is to detect the position and movement of the object to be detected, such as a finger, when the object to be detected is not in contact with the detection surface of the capacitive sensor 20. The touch detection is to detect the position and movement of the object to be detected when the object to be detected is in contact with the detection surface of the capacitive sensor 20.

The hover detection mode of the capacitive sensor 20 includes detection of the position and movement of the object to be detected when the capacitive sensor 20 is not in contact with the object to be detected. The touch detection mode includes detection of the position and movement of the object to be detected when the capacitive sensor 20 is in contact with the object to be detected.

The capacitive sensor 20 performs self-capacitance detection. The capacitive sensor 20 is so sensitive that it can perform hover detection. Therefore, the capacitive sensor 20 can detect the movement of the input keys 10 even when the insulating plate 30 is provided between the capacitive sensor 20 and the input device 100 serving as the object to be detected as illustrated in FIG. 2.

In the following description, a first direction Dx is one direction in a plane parallel to the substrate 23. A second direction Dy is one direction in the plane parallel to the substrate 23 and is orthogonal to the first direction Dx. The second direction Dy may intersect the first direction Dx without being orthogonal thereto. A third direction Dz is a direction orthogonal to the first direction Dx and the second direction Dy and is normal to the main surface of the substrate 23. The term “plan view” refers to the positional relation when viewed from a direction perpendicular to the substrate 23.

As illustrated in FIG. 3, the capacitive sensor 20 has a detection region SA and a peripheral region BE outside the detection region SA. The detection region SA is a region provided with the detection electrodes 21 to detect the object to be detected in proximity to the detection surface. The peripheral region BE is a region positioned outside the detection region SA and not provided with the detection electrodes 21. The peripheral region BE is a region provided with the peripheral electrodes 22 along the four sides of the detection region SA. The detection region SA according to the present disclosure is larger than the area of the input device 100 viewed from the third direction Dz (in plan view). Since the detection region SA is larger than the installation area of the input device 100, the area where the input keys 10 of the input device 100 can be detected on the insulating plate 30 is larger. Therefore, the input device 100 can be readily used simply by being placed on the insulating plate 30.

The detection electrodes 21 are planarly arranged in the detection region SA of the substrate 23 and disposed in a matrix (row-column configuration) in plan view. In other words, the detection electrodes 21 are adjacently arrayed in the first direction Dx and the second direction Dy. The detection electrodes 21 are each electrically coupled to the detection circuit 80 via wiring (not illustrated).

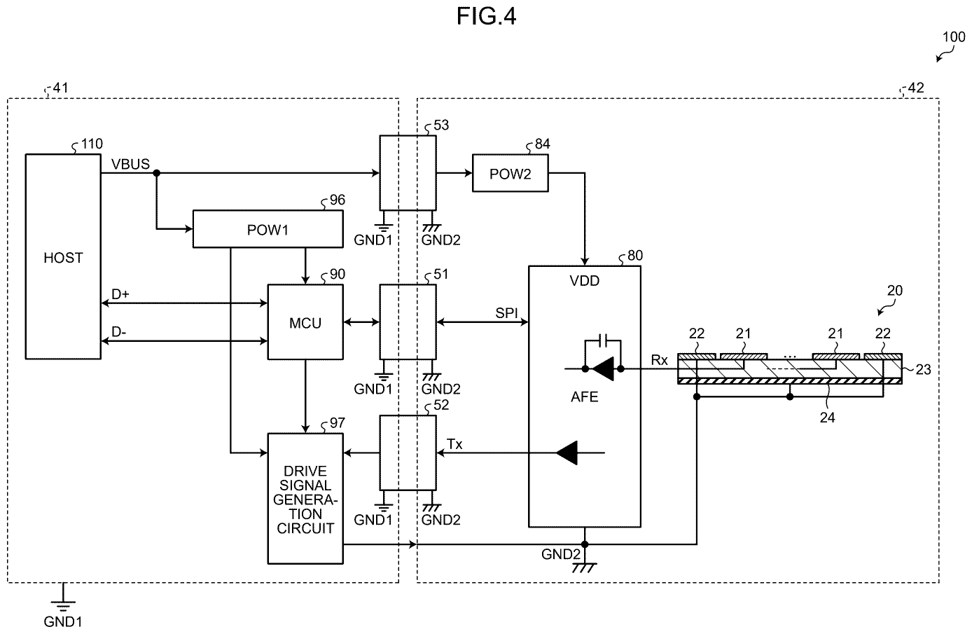

The peripheral electrodes 22 are disposed surrounding the detection electrodes 21 provided in the detection region SA. The peripheral electrodes 22 and the detection electrodes 21 are adjacently disposed on the substrate 23. The capacitive sensor 20 according to the first embodiment does not necessarily include the peripheral electrodes 22. The capacitive sensor 20 may be provided with a shield electrode 24 (refer to FIG. 4) on the surface of the substrate 23 opposite to the surface provided with the detection electrodes 21 and the peripheral electrodes 22.

FIG. 4 is a diagram for explaining the configuration of the capacitive sensor according to the first embodiment. As illustrated in FIG. 4, the input detection system 1 includes a first power supply circuit 96 (POW1), a second power supply circuit 84 (POW2), a drive signal generation circuit 97, a first isolator 51, a second isolator 52, and an isolated DC-DC converter 53 besides the capacitive sensor 20, the detection circuit 80, and the control circuit 90 described above.

In the present disclosure, the processing device 110, the control circuit 90, the first power supply circuit 96, and the drive signal generation circuit 97 are included in a first reference potential block 41. In the present disclosure, the second power supply circuit 84, the detection circuit 80, and the capacitive sensor 20 are included in a second reference potential block 42. The processing device 110, the control circuit 90, the first power supply circuit 96, and the drive signal generation circuit 97 included in the first reference potential block 41 operate with a first reference potential GND1, which is a fixed potential, as the ground potential. The second power supply circuit 84, the detection circuit 80, and the capacitive sensor 20 included in the second reference potential block 42 operate with a second reference potential GND2 generated by the drive signal generation circuit 97 as the ground potential.

The first power supply circuit 96 converts electric power supplied via a power supply line VBUS serving as a USB cable into voltage and supplies it to the control circuit 90 and the drive signal generation circuit 97.

The isolated DC-DC converter 53 provides isolation and transmits electric power between the processing device 110 and the second power supply circuit 84. The isolated DC-DC converter 53 transmits electric power by a magnetic isolation method.

In the isolated DC-DC converter 53, electric power is supplied to the coil on the first reference potential block 41 side via the power supply line VBUS serving as the USB cable, thereby causing the coil to generate a magnetic field. The coil on the second reference potential block 42 side is provided within an area of being affected by the magnetic field generated by the coil on the first reference potential block 41 side.

The coil on the second reference potential block 42 side generates an induced electromotive force due to the magnetic field generated by the coil on the first reference potential block 41 side. The electric power generated by the coil on the second reference potential block 42 side is supplied to the second power supply circuit 84.

The second power supply circuit 84 converts the electric power supplied from the isolated DC-DC converter 53 into voltage and supplies it to the detection circuit 80.

The detection circuit 80 generates a square wave signal Tx as a periodically varying potential having a periodic variation pattern. The square wave signal Tx contains fundamental frequency components and harmonic components of the drive signal supplied to the peripheral electrodes 22 and the shield electrode 24 of the capacitive sensor 20.

The detection circuit 80 acquires sensing data from the detection electrodes 21 and outputs it to the control circuit 90 via the first isolator 51.

Signals between the detection circuit 80 and the control circuit 90 according to the present disclosure are transmitted by a serial peripheral interface (SPI), which is a clock synchronous serial interface. The serial interface for transmitting the signals between the detection circuit 80 and the control circuit 90 is not limited to SPI.

The first isolator 51 provides isolation and signal transmission between the control circuit 90 and the detection circuit 80. The electrical signals input and output via the first isolator 51 are synchronized between the control circuit 90 and the detection circuit 80.

The second isolator 52 provides isolation and transmission of the square wave signals Tx between the detection circuit 80 and the drive signal generation circuit 97. The square wave signals Tx input and output via the second isolator 52 are synchronized between the detection circuit 80 and the drive signal generation circuit 97.

The second isolator 52 transmits the signals by an optical isolation method using a photocoupler, for example. The method of signal transmission between the control circuit 90 and the detection circuit 80 in the first isolator 51 may be the same as or different from the method of signal transmission in the second isolator 52. In other words, examples of the first isolator 51 include, but are not limited to, an optically isolated photocoupler, and a magnetically isolated digital isolator similar to the isolated DC-DC converter 53.

The first isolator 51 can perform bidirectional signal transmission, that is, signal transmission from the control circuit 90 to the detection circuit 80 and signal transmission from the detection circuit 80 to the control circuit 90. If an optically isolated photocoupler is used as the first isolator 51, a photocoupler that transmits signals from the control circuit 90 to the detection circuit 80 is coupled in parallel with a photocoupler that transmits signals from the detection circuit 80 to the control circuit 90.

The control circuit 90 transmits and receives signals, such as various kinds of information on the sensing data (detection value) and control commands, to and from the processing device 110.

Based on reference information (DP control reference data) indicating the correspondence between the fundamental frequency of the square wave signal Tx output from the detection circuit 80 and the electrical resistance of a digital potentiometer (not illustrated) included in the drive signal generation circuit 97, the control circuit 90 outputs, to the digital potentiometer, an electrical resistance setting command to set the electrical resistance of the digital potentiometer to an electrical resistance corresponding to the fundamental frequency of the square wave signal Tx output from the detection circuit 80. As a result, the electrical resistance of the digital potentiometer is controlled to the electrical resistance corresponding to the fundamental frequency of the square wave signal Tx.

The control circuit 90 also performs noise determination on the sensing data and position determination (coordinate calculation) on the object to be detected based on the sensing data. The noise determination is processing performed to determine the amount of noise components in the sensing data (detection value). The coordinate calculation is arithmetic processing performed to determine the position of (the object to be detected in proximity to) the object to be detected in proximity to the capacitive sensor 20. Specifically, the coordinate calculation can derive the position in the first direction Dx, the position in the second direction Dy, and the position in the third direction Dz (refer to FIG. 3) of the object to be detected in proximity to the capacitive sensor 20, for example. The coordinate calculation includes arithmetic processing performed to determine the position of the input device 100 placed on the capacitive sensor 20. Detailed explanation of the noise determination and the coordinate calculation is omitted herein because they are the same as those well-known.

Signals between the control circuit 90 and the processing device 110 according to the present disclosure are transmitted by USB, which is a serial interface. Specifically, the signals between the control circuit 90 and the processing device 110 are transmitted via signal lines D+ and D− of a USB cable. The serial interface for transmitting the signals between the control circuit 90 and the processing device 110 is not limited to USB.

In the configuration described above, the first reference potential block 41 including the processing device 110, the control circuit 90, the first power supply circuit 96, and the drive signal generation circuit 97 is electrically isolated from the second reference potential block 42 including the second power supply circuit 84, the detection circuit 80, and the capacitive sensor 20, with the isolated DC-DC converter 53, the first isolator 51, and the second isolator 52 interposed therebetween.

The first reference potential GND1 supplied to the first reference potential block 41 as the ground potential is a fixed potential held by a large electrode, such as a solid electrode. The second reference potential GND2 supplied to the second reference potential block 42 as the ground potential is a periodically varying potential generated by the drive signal generation circuit 97.

In the input detection system 1 according to the present disclosure, the variation period of the periodically varying potential (second reference potential GND2) is the same as the generation period of the square wave generated by the detection circuit 80 (square wave period of the square wave signal Tx). In other words, the second reference potential GND2 is a potential that periodically varies in synchronization with the square wave signal Tx generated by the detection circuit 80.

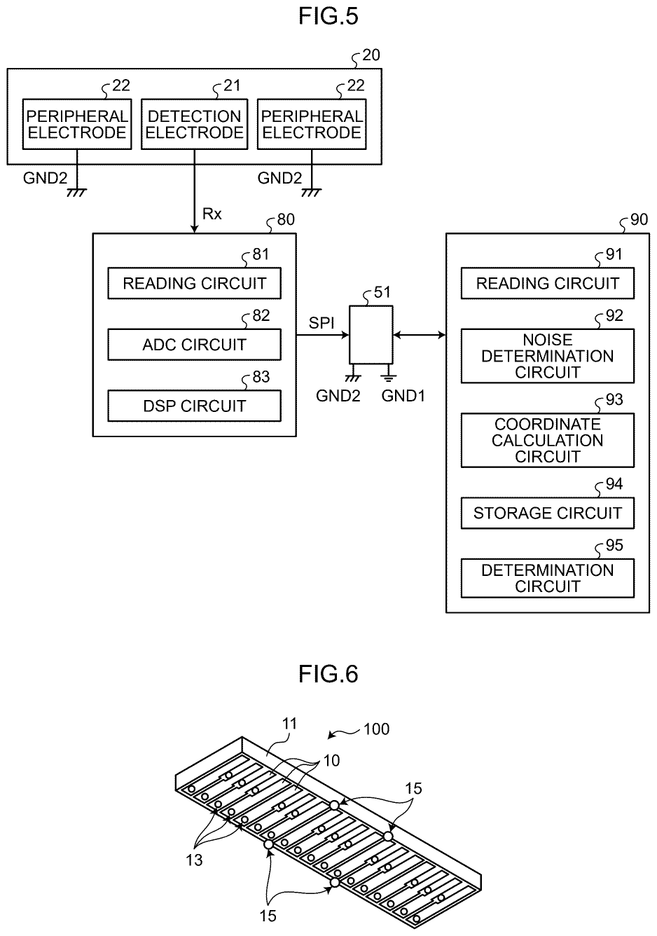

FIG. 5 is a diagram of an example of the functional circuit block configuration of the detection circuit and the control circuit.

As illustrated in FIG. 5, the detection circuit 80 includes a reading circuit 81, an analog digital converter (ADC) circuit 82, and a digital signal processor (DSP) circuit 83. Each circuit element of the detection circuit 80 operates with the second reference potential GND2, which is a periodically varying potential generated by the drive signal generation circuit 97, as the ground potential.

The reading circuit 81 acquires detection signals Rx from the respective detection electrodes 21. The reading circuit 81 is an analog front-end (AFE) circuit, for example.

The ADC circuit 82 converts the detection signals Rx acquired by the reading circuit 81 from analog signals into digital signals.

The DSP circuit 83 performs digital filtering on digital data resulting from conversion into the digital signals by the ADC circuit 82 to generate the detection signals Rx.

The detection circuit 80 outputs the sensing data (detection value) generated by the DSP circuit 83 to the control circuit 90 via the first isolator 51.

The control circuit 90 includes a reading circuit 91, a noise determination circuit 92, a coordinate calculation circuit 93, a storage circuit 94, and a determination circuit 95. Each circuit element of the control circuit 90 operates with the first reference potential GND1, which is a fixed potential, as the ground potential.

The reading circuit 91 acquires the sensing data (detection value) output from the detection circuit 80 via the first isolator 51.

The noise determination circuit 92 performs noise determination based on the sensing data (detection value) acquired by the reading circuit 91.

The coordinate calculation circuit 93 performs coordinate calculation based on the sensing data (detection value) acquired by the reading circuit 91.

The storage circuit 94 holds in advance various thresholds (a first threshold and a second threshold) for determining the depression of the input key 10 and the position of the input device 100.

The determination circuit 95 determines whether the input device 100 is present by comparing the sensing data (detection value), which is acquired by the reading circuit 91, with the first threshold or the second threshold held in the storage circuit 94.

The control circuit 90 has a function of changing the fundamental frequency of the square wave signal Tx output from the detection circuit 80. When the fundamental frequency of the square wave signal Tx output from the detection circuit 80 is changed, the control circuit 90 re-sets the electrical resistance of the digital potentiometer included in the drive signal generation circuit 97 corresponding to the changed fundamental frequency of the square wave signal Tx.

The control circuit 90 has a function of changing the fundamental frequency of the square wave signal Tx output from the detection circuit 80.

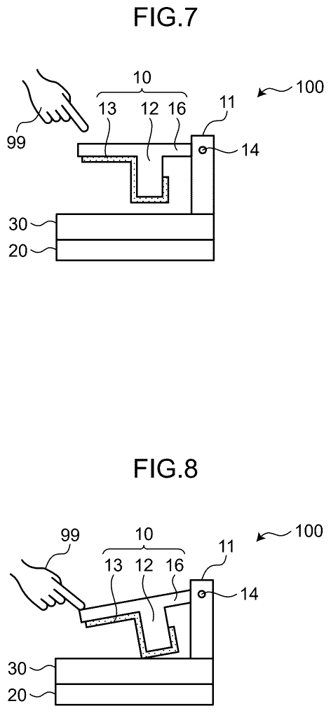

FIG. 6 is a schematic of the back surface of the input device according to the first embodiment. FIG. 7 is a schematic of a first operating state of the input key according to the first embodiment. FIG. 8 is a schematic of a second operating state of the input key according to the first embodiment.

As illustrated in FIG. 6, the housing 11 includes a plurality of reference conductors 15 on the back surface of the input device 100, which is the side in contact with the insulating plate 30. The input key 10 includes a detection conductor 13 on the back surface.

The storage circuit 111 (refer to FIG. 2) of the processing device 110 stores therein in advance information on the relative positional relation between the reference conductors 15 and the detection conductor 13.

When the housing 11 of the input device 100 moves with respect to the capacitive sensor 20 (refer to FIG. 2), the detection electrode 21 (refer to FIG. 3) of the capacitive sensor 20 at the position overlapping the reference conductor 15 of the input device 100 changes. As a result, the input detection system 1 illustrated in FIG. 2 can detect that the input device 100 has moved on the insulating plate 30.

In the first embodiment, the parasitic capacitance can be adjusted such that the sensing data (detection value) of the reference conductor 15 does not saturate, by appropriately adjusting the thickness of the insulating plate 30 illustrated in FIG. 2.

FIGS. 7 and 8 illustrate an example of the input key 10. The input device 100 includes the housing 11, the input key 10, and a pivot 14. The input key 10 includes a key top 16 and a protrusion 12 protruding downward from the key top 16. The key top 16 and the protrusion 12 are formed of insulating resin. The detection conductor 13 is a conductive foil made of copper, aluminum, or other metal. The insulating plate 30 is provided between the capacitive sensor 20 and the detection conductor 13.

The pivot 14 is a pin or the like. The pivot 14 fixes the key top 16 to the housing 11 such that the key top 16 does not move up, down, left, and right but is rotatable about the pivot 14. As illustrated in FIG. 7, a human body 99 does not depress the input key 10 in the first operating state. Therefore, the distance between the capacitive sensor 20 and the detection conductor 13 is large. In the first operating state, the capacitance of the human body 99 is not coupled to the detection conductor 13.

As illustrated in FIG. 8, the human body 99 depresses the input key 10 in the second operating state. Therefore, the distance between the capacitive sensor 20 and the detection conductor 13 is small. In the second operating state, the capacitance of the human body 99 is coupled to the detection conductor 13.

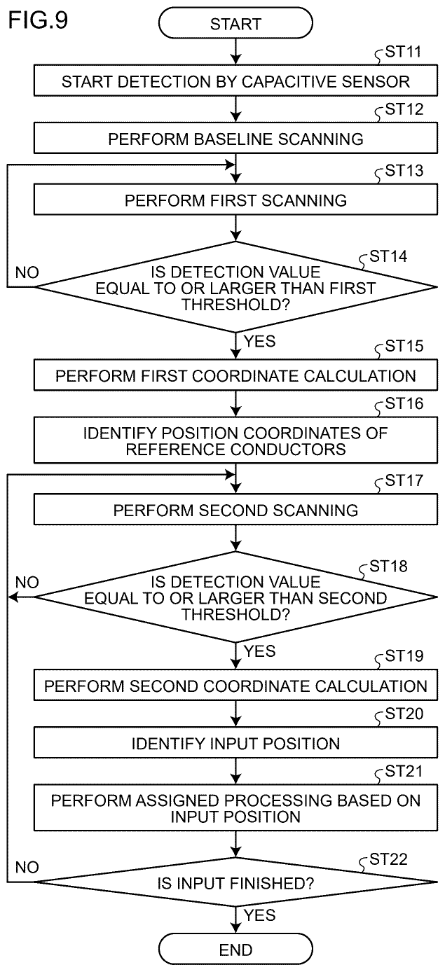

Next, the detection method of the input detection system 1 is described with reference to FIG. 9. FIG. 9 is a flowchart of an example of the detection method of the input detection system according to the first embodiment.

As illustrated in FIG. 9, the input detection system 1 starts detection by the capacitive sensor 20 (Step ST11). When the input device 100 is not present on the insulating plate 30, the detection circuit 80 acquires the detection signals Rx from the respective detection electrodes 21, and the control circuit 90 generates baseline data based on the detection signals Rx and stores it in the storage circuit 94 (Step ST12). The determination circuit 95 generates the first threshold based on the baseline data and stores it in the storage circuit 94.

As the thickness of the insulating plate 30 increases, the absolute value of the detection value decreases. The first threshold is set according to the baseline data, so that the input key 10 of the input device 100 can be detected independently of the thickness of the insulating plate 30.

The input detection system 1 starts detection by the capacitive sensor 20 (Step ST13). The determination circuit 95 of the control circuit 90 compares the sensing data (detection value) acquired from the detection electrode 21 of the capacitive sensor 20 with the first threshold held in advance in the storage circuit 94 (Step ST14). If the sensing data (detection value) is smaller than the first threshold (No at Step ST14), the detection by the capacitive sensor 20 in the first scanning is continued (Step ST13).

If the sensing data (detection value) is equal to or larger than the first threshold (Yes at Step ST14), the determination circuit 95 of the control circuit 90 calculates first coordinates corresponding to the positions of the reference conductors 15 of the input device 100 placed on the capacitive sensor 20 with the insulating plate 30 therebetween (Step ST15).

The position coordinates of the reference conductors 15 of the input device 100 are identified based on the first coordinates (Step ST16).

The input detection system 1 starts detection by the capacitive sensor 20 (Step ST17). The determination circuit 95 of the control circuit 90 compares the sensing data (detection value) acquired from the detection electrode 21 of the capacitive sensor 20 with the second threshold held in advance in the storage circuit 94 (Step ST18). If the sensing data (detection value) is smaller than the second threshold (No at Step ST18), the detection by the capacitive sensor 20 in the second scanning is continued (Step ST17).

If the sensing data (detection value) is equal to or larger than the second threshold (Yes at Step ST18), the determination circuit 95 of the control circuit 90 calculates second coordinates corresponding to the position of at least one detection conductor 13 of the input device 100 placed on the capacitive sensor 20 with the insulating plate 30 therebetween (Step ST19).

The position coordinates of the detection conductor 13 of the input device 100 are identified based on the second coordinates (Step ST20). Thus, the input position of the input key 10 that has been operated is identified.

The processing device 110 performs assigned processing based on the input position of the input key 10 subjected to a specific input operation, that is, the second coordinates (Step ST21). The input detection system 1 operates the display 71 and the speaker 72 according to the assigned processing.

If the input operation on the input detection system 1 is finished (Yes at Step ST22), the input detection system 1 terminates the sensing operation. The sensing operation is terminated, for example, when the supply of power to the input detection system 1 stops, when the processing device 110 outputs a command to terminate the sensing operation to the input detection system 1, or the like. If the input operation on the input detection system 1 is not finished (No at Step ST22), the input detection system 1 performs the processing from Step ST17 again.

As described above, the input device 100 includes at least one input key 10 that includes the detection conductor 13 and can change the distance between the detection conductor 13 and the insulating plate 30 depending on depression. The input detection system 1 includes the capacitive sensor 20, the input device 100, the detection circuit 80, and the control circuit 90. The capacitive sensor 20 is disposed on a first surface of the insulating plate 30 and provided with a plurality of detection electrodes 21 on the detection surface. The input device 100 is disposed on a second surface of the insulating plate 30. The detection circuit 80 is coupled to the capacitive sensor 20. The control circuit 90 controls the capacitive sensor 20 and the detection circuit 80. The control circuit 90 outputs an input signal corresponding to an input operation on the input device 100 based on the detection value output from the detection circuit 80 depending on the distance between the detection conductor 13 and the insulating plate 30. Thus, the input detection system 1 according to the first embodiment can operate various devices, such as the display 71 and the speaker 72, by using the pressing on the input key 10 as a trigger. The input detection system 1 accurately detects input operations. The input device 100 can be made thinner and readily used simply by being placed on the insulating plate 30.

The input detection system 1 includes the processing device 110 coupled to the control circuit 90. The reference conductors 15 is provided on the surface of the input device 100 facing the insulating plate 30. The storage circuit 111 of the processing device 110 stores therein in advance the relative positions of the reference conductors 15 and the detection conductor 13 as map information. The processing device 110 identifies the positions of the reference conductors 15 based on the detection value output from the control circuit 90. Thus, when the detection value equal to or larger than the first threshold is input and matches the map information, the processing device 110 determines that the input device 100 is placed on the insulating plate 30.

The operations of the display 71 and the speaker 72 illustrated in FIG. 2 are given by way of example only, and the results of detection of the object to be detected and the input device 100 and the operations of the display 71 and the speaker 72 may be combined in any desired manner. The input detection system 1 does not necessarily include both the display 71 and the speaker 72 and simply needs to include at least one of the display 71 and the speaker 72. Alternatively, the input detection system 1 may include other devices or the like besides the display 71 and the speaker 72.

### Second Embodiment

FIG. 10 is a schematic of the input device according to a second embodiment. An input device 100A includes input keys 10A. The input device 100A is an information input keyboard on which information is input by pressing the input keys 10A. The processing device 110 performs processing according to the information input on the input device 100A and displays the processing results on the display 71.

### Third Embodiment

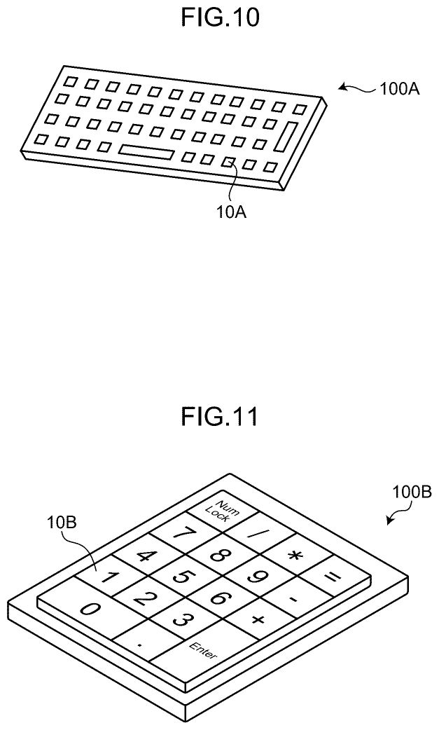

FIG. 11 is a schematic of the input device according to a third embodiment. An input device 100B includes input keys 10B. The input device 100B is a numeric keyboard on which numeric information is input by pressing the input keys 10B. The processing device 110 performs processing according to the information input on the input device 100B and displays the processing results on the display 71.

While exemplary embodiments according to the present disclosure have been described, the embodiments are not intended to limit the present disclosure. The contents disclosed in the embodiments are given by way of example only, and various modifications may be made without departing from the spirit of the present disclosure. Appropriate modifications made without departing from the spirit of the present disclosure naturally fall within the technical scope of the present disclosure. At least one of various omissions, substitutions, and modifications of the components may be made without departing from the gist of the embodiments and the modifications described above.

What is claimed is:

1. An input detection system comprising:
a capacitive sensor disposed on a first surface of an insulating plate and provided with a plurality of detection electrodes on a detection surface;
an input device that is disposed on a second surface of the insulating plate and comprises at least one input key including a detection conductor and capable of changing a distance between the detection conductor and the insulating plate depending on depression;
a detection circuit coupled to the capacitive sensor; and
a control circuit configured to control the capacitive sensor and the detection circuit, wherein
the control circuit is configured to output an input signal corresponding to an input operation on the input device based on a detection value output from the detection circuit depending on the distance between the detection conductor and the insulating plate.

2. The input detection system according to claim 1 further comprising a processing device coupled to the control circuit, wherein
a plurality of reference conductors are provided on a surface of the input device facing the insulating plate,
the processing device is configured to store therein in advance relative positions of the reference conductors and the detection conductor, and
the processing device is configured to identify positions of the reference conductors based on the detection value output from the control circuit.

3. The input detection system according to claim 2, wherein the processing device is configured to, when the detection value equal to or larger than a first threshold is input, determine that the input device is placed on the insulating plate.

4. The input detection system according to claim 3, wherein the processing device is configured to, when a detection value at coordinates of the reference conductor equal to or larger than a second threshold is input, perform processing to which a specific input operation is assigned correspondingly to the detection value at the coordinates of the reference conductor.

5. The input detection system according to claim 4, further comprising a speaker, wherein
the processing device outputs sound from the speaker as the specific input operation.
